(19) United States
(12) Patent Application Publication
(10) Pub. No.: US 2014/0282231 A1
(43) Pub. Date: Sep. 18, 2014

(54) DYNAMICALLY RECONFIGURABLE MULTIFRAME USER INTERFACE FOR A COMPUTING DEVICE

(71) Applicant: Vectorform, LLC, Royal Oak, MI (US)

(72) Inventors: Kevin Foreman, Troy, MI (US); Vasiliy Deych, Brooklyn, NY (US)

(73) Assignee: Vectorform, LLC, Royal Oak, MI (US)

(21) Appl. No.: 14/201,053

(22) Filed: Mar. 7, 2014

Related U.S. Application Data
(60) Provisional application No. 61/789,096, filed on Mar. 15, 2013.

(51) Int. Cl. G06F 3/0484

(52) U.S. Cl. CPC G06F 3/04847
USPC 715/792

(57) ABSTRACT

A user interface for a computing device includes a user interface form configured to fill a computing display. The user interface form is selectively and dynamically partitionable to define a plurality of non-overlapping frames, including a first frame and a second frame. Each of the plurality of non-overlapping frames includes an application window configured to display an instance of a software application being run by the computing device. A dynamic partition is disposed between the first frame and the second frame, and is configured to translate in a direction that is transverse to a longitudinal axis of the dynamic partition. The translation of the dynamic partition resizes each of the first frame and the second frame.

### CROSS REFERENCE TO RELATED APPLICATIONS

This application claims the benefit of U.S. Provisional Application No. 61/789,096, filed Mar. 15, 2013, which is hereby incorporated by reference in its entirety.

### TECHNICAL FIELD

The present invention relates to a dynamically reconfigurable user interface for a computing device.

### BACKGROUND

Computing devices typically include a user interface that is operative to visually present data to a user, and may provide the user with an ability to interact with one or more programs that are operating on the computer. With portable computing devices, such as tablet computers, slate computers, and laptop computers, a well designed user interface may enhance user productivity and enjoyment, particularly since the display area is often limited to a size that may be easily transported.

### SUMMARY

A user interface for a computing device includes a user interface form configured to fill a computing display. The user interface form is selectively and dynamically partitionable to define a plurality of non-overlapping frames, including a first frame and a second frame. Each of the plurality of non-overlapping frames includes an application window configured to display an instance of a software application being run by the computing device. A dynamic partition is disposed between the first frame and the second frame, and is configured to translate in a direction that is transverse to a longitudinal axis of the dynamic partition. The translation of the dynamic partition resizes each of the first frame and the second frame.

The user interface may further include an add button displayed via the display, wherein actuation of the add button configures the form to selectively create a new, third frame by resizing the first frame. Upon creation, the third frame is more proximate to an edge of the form than the first frame, and a second dynamic partition is disposed between the first frame and the third frame. Additionally, upon creation of the third frame, the third frame is configured to display an application menu containing a plurality of application buttons. Each application button corresponds to a one of the plurality of executable software applications. Actuation of one of the plurality of application buttons causes a corresponding software application to be executed within the third frame.

Following actuation of the add-button, an add-bar may be displayed proximate to an edge of the first frame and proximate to an edge of the form. The add-bar is a software button displayed via the display, where actuation of the add-bar creates the second dynamic partition parallel with the edge of the first frame proximate to where the add-bar is displayed.

Translation of the dynamic partition into the first frame decreases a dimension of the first frame that is transverse to the dynamic partition. In one configuration, the decreasing dimension is not permitted to be decreased below a predetermined minimum dimension. This predetermined minimum dimension defines a minimum dimensional boundary within the first frame. Additionally, a closing boundary may be disposed between the minimum dimensional boundary and an edge of the first frame. Upon an attempted translation of the dynamic partition to a location between the minimum dimensional boundary and the closing boundary, the dynamic partition automatically restores to a position coincident with the minimum dimensional boundary. Additionally, upon an attempted translation of the dynamic partition to a location between the closing boundary and the edge of the first frame, the first frame closes and is removed from the form.

A menu bar may be disposed proximate to an edge of the user interface form, and may be selectively displayable via the display. In one configuration, the menu bar includes a plurality of pre-defined template buttons, each configured to arrange the plurality of frames within the form in a different respective predetermined arrangement. The same menu bar, or a different menu bar may likewise include a plurality of recall buttons, each configured to recall a previously saved display environment, the previously saved display environment including form information, program identifying information, and program configuration information.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a computing device.

FIG. 2 is a schematic diagram of a user interface form that may run on a display of a computing device, with the form including an application area, a first menu bar, and a second menu bar.

FIG. 3 is a schematic diagram of the user interface form of FIG. 2, with the first and second menu bars hidden.

FIG. 4 is a schematic flow diagram of a method to selectively add a frame to a user interface form.

FIG. 5 is a schematic diagram of a user interface form presenting a user with an option to selectively add a frame to the form.

FIG. 6 is a schematic diagram of a user adding a frame to the user interface form of FIG. 5, via a tap-input.

FIG. 7 is a schematic diagram of a user adding a frame to the user interface form of FIG. 6, via a drag-input.

FIG. 8 is a schematic diagram of a user altering the position of a dynamic partition existing between a first frame and a second frame in a user interface form.

FIG. 9 is a schematic diagram of an application operative to run on a computing device, and including three differing display interfaces that may be selectable based on the size of a frame being used to display the application.

FIG. 10 is a schematic diagram of an application menu that may run within a frame of a user interface form.

FIG. 11 is a schematic diagram of a frame of a user interface form being used to display a drawing application.

### DETAILED DESCRIPTION

Referring to the drawings, wherein like reference numerals are used to identify like or identical components in the various views, FIG. 1 schematically illustrates a computing device 10 that may be used to provide an interactive computing experience to a user 12. The computing device 10 may resemble a desktop computer, a laptop computer, a tablet computer, a slate computer, a tabletop computer, or other similar styles of computers. In one configuration, the computing device may include a general purpose processor (GPP) 14, a graphical processing unit (GPU) 16, non-volatile memory 18, a display device 20, and a user input device 22.

The GPP 14 and GPU 16 may each be embodied as one or more distinct data processing devices, each having one or more microcontrollers or central processing units (CPU), read only memory (ROM), random access memory (RAM), electrically-erasable programmable read only memory (EEPROM), a high-speed clock, input/output (I/O) circuitry, and/or any other circuitry that may be required to perform the functions described herein. In one configuration, the GPP 14 and the GPU 16 may be separate devices; however, in other configurations, they may be physically embodied by a single integrated circuit. In general, the GPP 14 may be configured to run/execute various software programs, while the GPU 16 may be configured to render an output 24 of the GPP 14 into a visual data stream 26 that is capable of being displayed by the display device 20.

The non-volatile memory 18 may include a hard disk drive, such as a rotating platter magnetic drive, a solid-state flash drive, or any other similar form of long-term, non-volatile memory. The non-volatile memory 18 may contain program data and stored software applications that may be executed by the GPP 14. The GPP 14 may be digitally interconnected with the non-volatile memory 18, and may be configured to retrieve and execute the software applications in a manner that is known in the art.

The display device 20 may include a liquid crystal display (LCD), a light emitting diode display (LED), an organic light emitting diode display (OLED) and/or any similar style display/monitor that may exist or that may be hereafter developed. The display device 20 may serve to receive the visual data stream 26 provided by the GPU 16, and display it in a visual manner to a user 12.

The user input device 22 may include any style user input device that may exist in the art, such as, for example, a keyboard, mouse, joystick, track pad, track ball, photosensor, pressure sensor, capacitive touch interface, etc. In one particular configuration, as illustrated in FIG. 1, the user input device 22 may be integrated within the display device 20 as a touch-based input, which may allow the user 12 to seemingly interact with the display device 20 by touching and/or dragging items of interest within the visual output. In this manner, the user input device 22 may include a capacitive or touch-based digitizer that is integrated within the display device 20, and that can both detect contact from the user 12, and convert the digitized contact into a data stream 28. The data stream 28 may then be provided to the GPP 14 for user control of the various applications.

The GPP 14 may include various levels of operating code/routines that are all important for the overall function of the computing device 10. In a schematic and simplified manner, FIG. 1 generally illustrates that the GPP 14 may execute software code that defines an operating system 30. The operating system may generally be responsible for establishing a computing “environment,” assigning processing priorities to various applications running within the computing environment, and managing the interaction between software applications and computer hardware (among other things).

Within the operating system 30, the GPP 14 may run/execute various programs/applications 32 that are each designed to perform differing tasks. Examples of programs/applications 32 that may be run within the operating system 30 include (without limitation) word processor programs, drawing/drafting programs, internet browsing programs, games, computational programs, and database programs. In general, each application 32 may be distinct from every other application 32 that is simultaneously being run, however, the various applications 32 may have a limited ability to share data and/or otherwise interact with each other.

In addition to the various task-based programs/applications 32 within the operating system 30, the GPP 14 may also run/execute a graphical interface manager 34 application. The graphical interface manager 34 may be a software program run by/within the operating system 30, or alternatively may be directly integrated into the operating system 30. The graphical interface manager 34 may be responsible for arranging the visual display environment (which may be subsequently rendered by the GPU 16), and for coordinating the manner in which the user 12 may interact with and control various objects within the display environment.

FIG. 2 schematically illustrates one embodiment of a display environment 40 that may be created by the graphical interface manager 34. As shown, the display environment 40 generally includes a user interface (UI) “form” 42 that defines one or more application “frames” 44 (e.g., a first frame 46 and a second frame 48). Each frame 44 is configured to serve as the graphical display of a single program/application 32, however, multiple instances of the same program 32 may be run in separate frames.

As used herein, the UI “form” 42 is meant to refer to the general structure of the display, where a “frame” 44 more specifically refers to an individual element within the form 42. This is similar to the difference between the general structure of a house and one or more rooms defined within the house. The UI form 42 may be adjustable to fill a portion or all of the display area provided by the display device 20.

In one configuration, the UI form 42 may be configured to generally include at least three distinct elements: an application window 50, a first menu bar 52, and a second menu bar 54. Of the three elements, the application window 50 is allocated the majority of the available area within the UI form 42, and in some embodiments may extend across the entire UI form 42. The first and second menu bars 52, 54 may be disposed at opposing sides of the UI form 42, and in some embodiments, may be configured to selectively overlay the application window 50 only when requested by a user 12. For example, as generally illustrated in FIG. 3, in one configuration, if the first and second menu bars 52, 54 are hidden out of the field of view. A tab 56 or button 58 may exist within the UI form 42 that, when toggled by a user 12, will cause the respective first and/or second menu bars 52, 54 to reappear over the application window 50. Alternatively, the first and/or second menu bars 52, 54 may reappear over the application window 50 in response to a predefined input gesture of a user 12 (e.g., a touch and drag motion on the capacitive input display that originates proximate an edge of the display and extends toward the center of the display)

The application window 50 may be both selectively partitionable and dynamically partitionable into the one or more frames 44 at the command of a user 12. “Selectively partitionable” is intended to mean that one or more frames may be selectively created or destroyed by a user 12 at any time, and at the user's discretion. “Dynamically partitionable” is intended to mean that the one or more frames 44 are not static, and frame boundaries may be dynamically altered at any time, and at the user's discretion.

As generally illustrated in FIG. 3 the UI form 42 may generally be defined by an outer perimeter 60 that may ultimately be coincident with the outer edges of the display device 20 when rendered by the GPU 16. The first and second frames 46, 48 may be entirely disposed within the outer perimeter 60, and may be internally separated by a dynamic partition 62 that generally defines a longitudinal axis 63. Each of the first and second frames 46, 48 may define a respective application area 64, which may be adjacent to a respective control bar 66 disposed within the frame 44. In one configuration, the sum of all application areas 64 and control bars 66 across all of the frames 44 (plus the area consumed by any dynamic partitions 62), may equal the entire area defined by the outer perimeter 60 of the UI form 42. Additionally, the interface manager 34 may not permit free global translation of the frames 44 relative to the outer perimeter 60 of the UI form 42, nor may it permit frames 44 to be partially or completely overlaid on top of each other. In this manner, the UI form 42 may not include any perceived depth that may allow the frames 44 to be translated in separate planes.

Referring again to FIG. 2, in one configuration, the first menu bar 52 may be configured to allow a user 12 to selectively partition the UI form 42. As illustrated, the first menu bar 52 may include one or more pre-defined template buttons 70 that may automatically reconfigure the entire UI form 42 with a single user input (e.g., toggling the button 70). Additionally the first menu bar 52 may include an “add” button 72 that may allow for the selective creation of new frames 44, one at a time.

Each of the pre-defined template buttons 70 may include a schematic image of the UI form 42 that it may create if pressed. In this manner, a user 12 may easily visualize the stored form, and select the button 70 as required. In one configuration, these pre-defined template buttons 70 may be entirely pre-programmed and not customizable by the user 12. In another configuration, each button 70 may be dynamically adjusted by the user 12 and/or by the interface manager 34 according to a user's history or pattern of use. If a user 12 toggles any of the template buttons 70, the application window 50 may be automatically reconfigured to resemble the image displayed by the button 70.

If a user merely wishes to add a single new frame 44 to the application window 50, the user 12 may instead toggle the add button 72. The add button 72 may follow one general rule: any existing frame may be subdivided, so long as the subdivision does not cause a frame within the form to be smaller than a predefined minimum size.

FIG. 4 illustrates a method 80 that may be performed upon toggling of the add button 72. The method begins at step 82 when the add button 72 is toggled (or when a suitable swipe gesture, key stroke combination, or other such input is performed). In step 84, the interface manager 34 may examine/poll the horizontal dimension 100 and vertical dimension 102 for each existing frame 44. FIG. 5 generally illustrates a UI form 42 that includes a first frame 46 and a second frame 48, and generally illustrates the respective dimensions 100, 102 of each (specifically identified as dimensions 100a and 102a for the first frame 46, and dimensions 100b and 102b for the second frame 48).

In step 86, the interface manager 34 may compare each respective dimension 100a, 100b, 102a, and 102b to a predetermined minimum dimension. If the existing dimension is greater than twice the predetermined minimum dimension, then the subdivision may be allowed (at step 88) for that dimension (i.e., the frame 44 may be split into two resulting frames, where neither are below the minimum size). If, however, a dimension is less than twice the predetermined minimum dimension, then the subdivision may be disallowed for that dimension (at step 90). In the example provided in FIG. 5, dimension 100a is illustrated as being less than twice the minimum dimension.

In step 92, for all subdivisions that are allowed, the interface manager 34 may display an add-bar 104 (or other suitable toggle/indicator) at an edge of the frame transverse to the allowed dimension. Edges that are transverse to disallowed dimensions may remain unchanged. In one configuration, the add-bar 104 may preferentially be displayed near frame edges that are coincident with the outer perimeter 60 of the UI form 42. Referring again to FIG. 5, the first frame 46 may be capable of being split only along the vertical dimension 102a, while the second frame 48 may be split along either dimension 100b, 102b.

In step 94, the interface manager 34 may receive an input from the user 12. The input may come in one of two forms: a single toggle (momentary tap/release) on an add-bar 104; or a tap/drag that originates from an add-bar 104. If a single toggle is received at step 94, then in step 96, the interface manager 34 may subdivide the existing frame/dimension by placing a dynamic partition 62 transverse to, and at the centerpoint of the subdivided dimension.

FIG. 6 schematically illustrates the UI form 42 of FIG. 5, following a single toggle on the right-most add-bar 104. As shown, the existing second frame 48 is pushed toward the interior of the form 42, while a new (third) frame 106 slides in from the perimeter 60 of the form 42. The second and third frames 48, 106 may be separated by a new dynamic partition 108 that appears at the centerpoint of previous dimension 102b. Once the new frame 106 is created, the add-bar(s) 104 may disappear until a new partition is requested.

Referring again to FIG. 5, if a tap/drag input is received at step 94, then in step 98, the interface manager 34 may create a new dynamic partition 110 underneath the user input (e.g., under the user's finger) that is movable until the input is released (as generally illustrated in FIG. 7). In this manner, the drag input 112 may make the user feel as if the dynamic partition 110 is being dragged into the existing frame from the add-bar 104 under their direction. As the dynamic partition 110 is transitioned away from the perimeter 60 of the form 42, a new (fourth) frame 114 may be created between the partition 114 and the perimeter 60.

Upon release of the user input, the dynamic partition 110 may be frozen in place, so long as the newly created frame 114 does not have dimension that is less than the predetermined minimum dimension. If the user 12 attempts to place the dynamic partition 110 in a position that violates a minimum dimension rule, then the partition 110 may automatically be moved to a location that is closest to the user's input though greater than or equal to the predetermined minimum dimension.

The predetermined minimum dimensions for a frame 44 may be established in a manner that promotes a certain minimum amount of usability for a program 32 operating in the frame 44. The minimum dimensions may be established in advance so that application developers may design the respective applications/programs 32 in the most usable manner possible, without risk that features within the program may be crowded or lost from the field of view. The minimum dimensions may be specified in various manners, such as for example, pixel count, a percent of the application window dimensions, an absolute distance (e.g., millimeters of the display size), or in other similar manners.

Once a particular form is established, the defined frames may be dynamically resized by selecting a dynamic partition between two frames and dragging it in a direction transverse to that particular partition (i.e., transverse to the longitudinal axis 63 of the respective partition). For example, as shown in FIG. 8, in a 2-frame UI form 120, a first frame 122 and a second frame 124 may be separated by a dynamic partition 126, and may initially have an approximately equal size (i.e. where each frame occupies approximately 50% of the application window 50).

Once selected by a user 12, the partition 126 may be moved within the application window 50 along a direction 128 that is transverse to the partition 126. If the partition 126 is selected and dragged into/toward the second frame 124, the second frame may shrink in the direction 128 transverse to the partition 126 (i.e., frame dimension 130 may be reduced), while the first frame 122 may expand in the direction 116 transverse to the partition 126. The partition 126 may be transitionable up to a point where the decreasing dimension 130 of the shrinking frame 124 reaches a predetermined minimum dimension 132 (indicated by the minimum dimensional boundary line 134).

In the example illustrated by FIG. 8, if the partition 126 is attempted to be slid/dragged past the minimum dimensional boundary 134 by the user 12, the partition 126 may simply hold at the minimum dimensional boundary 134. In one configuration, continued urging to reduce the size of the second frame 124 may cause the frame 124 to simply close, leaving only a single frame form (e.g., the first frame 122). In this configuration, a closing boundary 136 may exist between the minimum dimensional boundary 134 and the form perimeter 60. If the partition 62 is attempted to be dragged beyond the closing boundary 136 (e.g., into a region 138 defined between the closing boundary 136 and the perimeter 60), the frame 124 may close. If, instead, the dimension 130 of the second frame 124 between the minimum dimensional boundary 134 and the closing boundary 136 (e.g., in region 140), the partition 126 may snap back to the minimum frame size 134 to avoid having the frame 124 inadvertently close. Said another way, dragging the dynamic partition 126 into a closing region 138 may cause the frame 124 to close/disappear from the UI form 110. Alternatively, dragging the dynamic partition 126 into a minimum size region 140 may cause the frame 124 to be sized at the minimum allowable dimension 132.

During a dynamic resize, the interface manager 34 may only accept the resized form 110 when the user 12 releases the drag (e.g., removes their finger from the capacitive touch input, or releases a mouse button on a desktop computer). Once the drag is released, the new form is set, and the new frame dimensions 142 may then be passed to each of the respective program instances (as shown in FIG. 1).

In one configuration, each program/application 32 may be configured to alter its behavior and/or appearance as a function of the size of the frame 44 that it is operating within. For example, as shown in FIG. 9, an application 32 may be created to include three differing display interfaces: i.e., a compact interface 150, a standard interface 152, and an expanded interface 154. Based on the frame dimensions 142, the application 32 may tailor its appearance and/or functional behavior to the actual size of the frame it is operating within. For example, if a frame dimension 142 is small (e.g., less than 33% of the size of the application window 50), the application 32 may select the compact interface 150. If the frame dimension 142 is mid-sided (e.g., between 33% and 66% of the size of the application window 50), the application 32 may select the standard interface 152. Finally, if the frame dimension 142 is large (e.g., greater than 66% of the size of the application window 50), the application 32 may select the expanded interface 154. In another configuration, the compact, standard, and expanded interfaces 150, 152, 154 may exist for each of the horizontal and vertical dimensions (thus providing 9 potential interface sizes).

The following is an illustrative example of what is meant by the different interfaces: In a weather application, a compact interface 150 may be configured to show simple textual data information, such as the current temperature, barometric pressure, windspeed, and predicted high/low temperatures for the current day. The display may be kept minimal, yet informative. For additional detail, action buttons may be included within the interface 150 to expand maps, textual weather descriptions, forecasts, etc.

In a standard interface 152, a broader range of options and displays may be available from a single interface. For example, in addition to the temperature display present in the compact interface 150, the standard interface 152 may include a 3, 5, or 7 day forecast, and/or more detailed textual forecasts.

Finally, the expanded interface 154 may provide a significantly greater and/or expanded array of graphical and/or visual information. In an expanded interface 154, the weather application mentioned above may include the same information present in the standard interface 152, though with more/additional detail, radar maps, or other such features. As discussed above, changing between various different interfaces may occur through the resizing/translation of dynamic partitions, caused by the user 12.

Upon the creation of a new frame, whether by the use of a template or by subdividing an existing frame, an application listing/menu may be initially displayed to allow a user 12 to control the use of the frame. FIG. 10 provides a schematic representation 160 of an application menu 162 that may be presented to a user 12 when a new frame is created. The application menu 162 may allow a user 12 to choose an application 32 to run in the newly created frame 44, and may be displayed as a plurality of graphical icons (as shown), as a textual listing, or as a textual listing plus associated icons.

As mentioned above, the available applications 32 may include traditional computer applications, such as a sound recorder, web browser, clock, calculator, word processor, drawing application, video/television player, as well as a calendar, task manager, email client, RSS reader, etc. Additionally, other more user specific applications may be included in the application listing if those applications are authorized to run on the particular machine (either via purchasing and downloading the application executable files, or via user specific access rights for web-based applications). Examples of these user-specific applications may include games, retail catalog browsers, advance photo editing software, advanced word processing software or spreadsheet software, etc.

In one configuration, one application that may be available from the application menu 162 may include an internet-connected application store/marketsite 164. Within the application store/marketsite 164, a user 12 may browse available programs, and selectively purchase particular programs of interest. Upon purchase, the program files for the purchased application may be downloaded on to the local machine via the internet, and may be available in the application menu 162 upon the creation of subsequent frames 44.

When a program 32 is executed by the GPP 14 following selection in the application menu 162, it may be self-contained within a processing thread that is distinct and/or independent from other displayed program instances. In this manner, if a fault occurs in one particular program instance/frame, it may not affect the other instances/frames. In another embodiment, all program instances may run in a common processing thread, and may share common memory, hardware resources, and certain low level machine functionality.

Referring again to FIG. 2, as mentioned above a second menu bar 54 may be disposed at an edge of the UI form 42 that may be opposite the first menu bar 52. The second menu bar 54 may be operative to save and restore a layout that a user 12 may have previously established. In one configuration, the second menu bar 54 may include a save button 170 and a plurality of recall buttons 172. If a user 12 establishes a particular UI form 42 that is of particular usefulness, the user 12 may save the layout into memory 18, where it may then be represented schematically as one of the plurality of recall buttons 172. As further illustrated in FIG. 2, the recall buttons may include graphical lines illustrating the layout of the UI form 42, and may also include one or more graphics/icons that illustrate the nature of each program 32 operating within the one or more frames 44.

Referring again to FIG. 1, upon selecting the save button 170, the interface manager 34 may store the display environment into memory 18 by recording the arrangement of the current UI form (i.e., form information 174), the nature of the programs operating within the current form (i.e., program identifying information 176), and any special user customized characteristics and/or data of the operating programs (i.e., program configuration information 178). Examples of special user customized characteristics/data may include simple data, such as time-zones for clocks and locations for weather applications, or more complex information such as file references for note-taking applications, internet bookmarks, virtual private networking (VPN) configuration information, or customized playlist information for audio playback. In this manner, upon selecting a recall button 172, the saved data may be recalled into the interface manager 34, with the stored program instances/frames being recalled in the same configuration in which they were saved. This suspend-like functionality may allow a user 12 to customize a plurality of user display environments 40, with each be independently customized for a particular use or purpose.

FIG. 11 illustrates an example of a frame 190 that may be used to display a drawing application. As described above, the frame 190 may define a respective application area 64, and may include control bar 66 disposed, for example, along the top edge of the application area 64. The control bar 66 may include a first predefined area 192 for application-specific controls, and a second predefined area 194 that may include an application identifier 196 and/or may act as a toggle to display an application menu 162 into the application area 64 (e.g., operative to allow a user 12 to change the displayed program within the frame). Alternatively, an icon 198 within the second predefined area 194 may be operative as a toggle to display certain frame/system-specific menu options within the application area 64.

As generally illustrated in FIG. 11, the first predefined area 192 may include one or more application buttons, such as buttons 200, 202, and 204. As shown, in the drawing application, the second and third buttons 202, 204 may include a trash-can button 202 that may delete the entire user drawing, and a share button 204 to communicate the drawing with one or more external devices or networks.

The first button 200 in the first predefined area 192 may be a dynamic undo button 200 that may exist as a default application button in a plurality of applications 32. The dynamic undo feature may include a slider 206 that is disposed on a scale 208 that is intended to represent time. The slider 206 and scale 208 may be hidden until the button 200 is toggled. Once visible, the scale 208 may originate from the undo button 200 and extend outward from there. A point 210 on the scale 208 that is closest to the button 200 may represent the current version of the drawing 212 (or alternatively, the current state of the active document/file/program that is running in the application area 64). As such, the slider 206 may be initially disposed proximate to the button 200 at the current time point 210. The opposing end 214 of the scale 208 from point 210 may represent the creation of the document/file, or alternatively may represent the last save point of the document, or the state of the document when the program was most recently opened.

During use of the application 32, the GPP 14 may record and/or keep a limited log of each sequential user input for each application 32. When the dynamic undo button 200 is toggled, the scale 208 may be subdivided by the total number of sequential user inputs for that application 32. As the slider 206 is transitioned along the scale 208 away from the button 200, the various user inputs may be sequentially rolled back or undone. In this manner, movement of the slider 206 along the scale 208 may appear to roll back time and/or progress within the document.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A user interface for a computing device having a display device and a plurality of executable software applications, the user interface comprising:
a user interface form configured to entirely fill the display device, the user interface form being selectively and dynamically partitionable to define a plurality of non-overlapping frames, including a first frame and a second frame;
wherein each of the plurality of non-overlapping frames includes an application window configured to display a software application selected from the plurality of executable software applications; and
a dynamic partition disposed between the first frame and the second frame;
wherein the dynamic partition is configured to translate in a direction that is transverse to a longitudinal axis of the dynamic partition; and
wherein the translation of the dynamic partition resizes each of the first frame and the second frame.

2. The user interface of claim 1, further comprising an add-button displayed via the display device, wherein actuation of the add button configures the form to selectively create a third frame by resizing the first frame;
wherein the third frame is more proximate to an edge of the form than the first frame; and
wherein a second dynamic partition is disposed between the first frame and the third frame.

3. The user interface of claim 2, wherein, upon creation of the third frame, the third frame is configured to display an application menu containing a plurality of application buttons, each application button corresponding to a respective one of the plurality of executable software applications; and
wherein actuation of one of the plurality of application buttons causes the corresponding one of the plurality of executable software applications to be executed within the third frame.

4. The user interface of claim 2, further comprising an add-bar disposed proximate to an edge of the first frame and proximate to an edge of the form;
wherein the add-bar is configured to be displayed via the display following actuation of the add button;
wherein the add-bar is a software button displayed via the display such that actuation of the add-bar creates the second dynamic partition; and
wherein the second dynamic partition is parallel to the edge of the first frame.

5. The user interface of claim 1, wherein translation of the dynamic partition into the first frame decreases a dimension of the first frame that is transverse to the dynamic partition; and
wherein the dimension is not permitted to be decreased below a predetermined minimum dimension.

6. The user interface of claim 5, wherein the predetermined minimum dimension defines a minimum dimensional boundary within the first frame;
wherein a closing boundary is disposed between the minimum dimensional boundary and an edge of the first frame;
wherein upon an attempted translation of the dynamic partition to a location between the minimum dimensional boundary and the closing boundary, the dynamic partition automatically restores to a position coincident with the minimum dimensional boundary; and
wherein upon an attempted translation of the dynamic partition to a location between the closing boundary and the edge of the first frame, the first frame closes and is removed from the form.

7. The user interface of claim 1, further comprising a menu bar disposed proximate an edge of the user interface form, the menu bar being selectively displayable via the display device;
wherein the menu bar includes a plurality of pre-defined template buttons, each configured to arrange the plurality of frames within the form in a different respective predetermined arrangement.

8. The user interface of claim 1, further comprising a menu bar disposed proximate an edge of the user interface form, the menu bar being selectively displayable via the display device;
wherein the menu bar includes a plurality of recall buttons, each configured to recall a previously saved display environment, the previously saved display environment including form information, program identifying information, and program configuration information.

9. A computing device comprising:
a processor configured to host a graphical interface manager and a plurality of software applications, wherein the graphical interface manager is configured to manage a display environment;
a display device in communication with the processor and configured to visually present the display environment across a display area; and
a user input device configured to receive an input from a user and provide a data stream to the processor corresponding to the received input;
wherein the display environment includes:
a user interface form configured to fill the entire display area, the user interface form being selectively and dynamically partitionable to define a plurality of non-overlapping frames including a first frame and a second frame,
wherein each of the plurality of non-overlapping frames includes an application window configured to display a software application selected from the plurality of software applications;
a dynamic partition disposed between the first frame and the second frame;
wherein the dynamic partition is configured to translate in a direction that is transverse to a longitudinal axis of the dynamic partition in response to an input received by the user interface; and
wherein the translation of the dynamic partition resizes each of the first frame and the second frame.

10. The computing device of claim 9, wherein the display environment further includes an add-button, wherein actuation of the add-button via the user input device configures the graphical interface manager to selectively create a third frame by resizing the first frame;
wherein the third frame is more proximate to an edge of the form than the first frame; and
wherein a second dynamic partition is disposed between the first frame and the third frame.

11. The computing device of claim 10, wherein, upon creation of the third frame, the graphical interface manager is configured to display an application menu within the third frame;
wherein the application menu includes a plurality of application buttons, each application button corresponding to a respective one of the plurality of software applications; and
wherein actuation of one of the plurality of application buttons via the user input device causes the processor to run the corresponding one of the plurality of software applications within the third frame.

12. The computing device of claim 10, wherein the graphical interface manager is configured to display an add-bar disposed proximate to an edge of the first frame and proximate to an edge of the form following actuation of the add button;
wherein the add-bar is a software button displayed via the display such that actuation of the add-bar via the user input device creates the second dynamic partition; and
wherein the second dynamic partition is parallel to the edge of the first frame.

13. The computing device of claim 9, wherein translation of the dynamic partition into the first frame decreases a dimension of the first frame that is transverse to the dynamic partition; and
wherein the dimension is not permitted to be decreased below a predetermined minimum dimension.

14. The computing device of claim 13, wherein the predetermined minimum dimension defines a minimum dimensional boundary within the first frame;
wherein a closing boundary is disposed between the minimum dimensional boundary and an edge of the first frame;
wherein upon an attempted translation of the dynamic partition to a location between the minimum dimensional boundary and the closing boundary, the dynamic partition automatically restores to a position coincident with the minimum dimensional boundary; and
wherein upon an attempted translation of the dynamic partition to a location between the closing boundary and the edge of the first frame, the first frame closes and is removed from the form.

15. The computing device of claim 9, wherein the display environment further includes a menu bar disposed proximate an edge of the user interface form, the menu bar being selectively displayable via the display;
wherein the menu bar includes a plurality of pre-defined template buttons, each configured to cause the graphical interface manager to arrange the plurality of frames within the form in a different respective predetermined arrangement.

16. The computing device of claim 9, wherein the display environment further includes a menu bar disposed proximate an edge of the user interface form, the menu bar being selectively displayable via the display;
wherein the menu bar includes a plurality of recall buttons, each configured to cause the graphical interface manager to recall a previously saved display environment, the previously saved display environment including form information, program identifying information, and program configuration information.
